(19) United States
(12) Patent Application Publication
(10) Pub. No.: US 2011/0130950 A1
(43) Pub. Date: Jun. 2, 2011

(54) TRAVEL DIRECTIONS WITH TRAVEL-TIME ESTIMATES

(76) Inventors: Yonatan Wexler, Redmond, WA (US); Eyal Ofek, Redmond, WA (US)

(21) Appl. No.: 12/629,778

(22) Filed: Dec. 2, 2009

(51) Int. Cl. G01C 21/36

(52) U.S. Cl. 701/200

(57) ABSTRACT

Travel directions may be provided with an estimate of the amount of time that it takes to traverse the route at various times of day. In one example, data is collected regarding the traffic along a route, as well as other factors that may affect the time it takes to traverse the route. The collected data is associated with a particular time, so that it is possible to know, for example, that traffic moves at an average speed of X from 1-2 p.m., an average speed of Y from 2-3 p.m., and so on. Directions may be presented to a user in a way that reflects the varying amount of time that it takes to traverse a route at different times of day. For example, a chart or graph showing how travel time changes throughout the day may be presented.

### BACKGROUND

Map applications, such as Bing Maps, Google Maps, etc., are often used to provide directions. A user typically specifies starting and ending locations (and possibly some intermediate points), and the map application plans a route that goes from the starting location to the ending location (passing through the intermediate points, if they are specified). Such applications often calculate an estimate of the time that it will take to travel the route. The time estimate is generally based on data that represents the current traffic at the moment that the user interact with the system integrated along the route. For example, if a set of directions from Redmond, Wash., to Seattle, Wash., says “Take state route 520 west for 10 miles, and then take Interstate 5 south for 2 miles,” the system adds the current speeds of travel along these particular stretches of SR-520 and I-5. Thus, the current amount of time that it takes to travel the entire route can be calculated by adding the current amount of time that it takes to travel each stretch of the route.

A problem that arises in providing a time estimate is that the amount of time that it takes to travel a given route tends to vary depending on the time of day. For example, a route may be crowded during rush hour, but may be clear in the middle of the afternoon or late evening. But typical map applications simply give the user only the current amount of time that it takes to travel the route, which does not take into account the time at which the user is actually going to travel the route. For example, when a user is interested in a real estate, he might be interested in the average travel time during rush hour, and not the time it takes to travel when he interacts with the system (Furthermore, the travel time in one rush hour instance may not represent the yearly or seasonal average.) Some automobile navigation systems download current traffic conditions and estimate the time it currently takes to travel based on the current traffic conditions. However, when a user is requesting directions through a map application, the user is typically asking for directions that the user will use at some unspecified time in the future (since the user will often travel after the interaction).

### SUMMARY

A map application may be created that provides directions for a given route, and that also provides information about how long it will take to travel the route at various times of day. In order to provide time information along with the directions, information may be collected concerning the traffic patterns along various stretches of road. The information may be associated with a particular time. For example, there may be sensors along State Route 520 that determine how fast traffic is moving at a particular point in time—e.g., at 5:35 p.m. traffic was detected to be moving at 19 miles per hour. These data points may be collected in bins that represent different time intervals. For example, there could be one interval for each hour of the day (e.g., a bin for 12 a.m. to 1 a.m., another bin for 1 a.m. to 2 a.m., etc.). As another example, the bins could take into account both specific times and specific days, since traffic might be different on a Saturday than it is on a Monday; thus, Saturday from 12 a.m. to 1 a.m. might be a different bin than Monday from 12 a.m. to 1 a.m.

When sufficient data is collected in the bins, an average is calculated for each bin. Thus, given sufficient data, it is possible to determine that the average speed at a given point along State Route 520 is, say, 21 m.p.h. between 5 p.m. and 6 p.m., and 45 m.p.h. between 2 p.m. and 3 p.m. Similar statistics can be collected for any point on any road at which data is available.

When a user asks for directions, a map application plans a route, and then uses the statistics to calculate how long it will take to travel the route at different times of day. The amount of time that it takes to travel a route at different times of day may be presented to a user in some manner. For example, the user could be presented with a list that says how long the application estimates it will take to travel the route at different times of day. Or, the application could present a graph to the user, showing how the travel time increases or decreases throughout the day. Or, the system could ask the user what time of day he or she intends to travel, and could present a route that is calculated to take the smallest amount of time at the time of day the user has specified. Or, as yet another example, the system could take into account the fact that traffic patterns may change through time as the user drives the route. For example, a driver might leave Seattle heading south toward Portland, Oregon at noon. When the driver leaves Seattle, traffic may be light in the middle of the day, but by the time the driver arrives in Portland it may be rush hour with heavier traffic.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example of some information that an application could present to a user concerning a route between two points.

FIG. 2 is a block diagram of an example system that may collect data about traffic conditions.

FIG. 3 is a flow diagram of an example process in which data may be collected about traffic patterns at different times, and in which such data may be used to provide information about how long it will take to travel a route.

FIG. 4 is a block diagram of an example way to present information to a user about the travel times for different routes.

FIG. 5 is a block diagram of example components that may be used in connection with implementations of the subject matter described herein.

### DETAILED DESCRIPTION

Map applications are used to provide directions from one place to another. Typically, the user lists the starting point, the ending point, and possibly a set of intermediate points. The application then uses geographic data to plan a route from the start to the end, passing through the intermediate points if specified. The application then provides instructions on how to follow the route (e.g., “Start on Main Street, go 1.5 miles, take the exit ramp to State Route 520”). Typically, the application also calculates the amount of time that it will take to traverse the route. There may be different modes of travel (e.g., driving, walking, bus, etc.), and the application may provides estimates of how long it will take to traverse the route using the different modes of travel.

One issue that arises is that the amount of time that it takes to travel a route may depend on the time at which the route is being traveled. Traffic patterns along roads tend to vary throughout the day, or even across days. It may take twenty minutes to traverse a stretch of road at 11:00 a.m. in the morning, but at 5:30 p.m. (which is typically rush hour), it might take an hour to traverse the same stretch of road. Moreover, the amount of time that it takes to traverse a stretch of road may vary based on both the day and the time. For example, a road may be crowded and slow at 5:30 p.m. on Monday through Friday, but the same road might be relatively clear at 5:30 p.m. on Saturday and Sunday. Map applications typically estimate the time to traverse a route based on the up-to-date current traffic patterns that exist on that route, but the traffic pattern at any given time might differ significantly from the average. Some map applications may estimate the travel time based on current conditions, rather than based on some overall average, but one problem is that a user might request directions at one time and might plan to travel the route at a different time.

Estimating the time for auto travel presents a problem, but estimating the time for other types of travel can present related problems. For example, a given trip by train may take longer during rush hour than in the middle of the day, since at rush hour there may be a higher volume of trains on the railroad, and each train may make longer stops to take on or discharge a larger number of passengers. Additionally, trains (and busses, and ferries, etc.) depart at discrete times (e.g., 5:00 p.m., 5:15, 5:30, etc.), so the amount of time that it takes to travel by train may include the amount of time the person spends waiting for the next train. For example, if a train departs every 15 minutes (at, say, :00, :15, :30, and :45 after the hour) for a one-hour journey to some destination, then the amount of travel time is one hour if a person starts traveling at 5:00, but is one hour and fourteen minutes if a person starts traveling at 5:01, since in the latter case the trip includes fourteen minutes of time waiting for the next train. In general, it can be said that the amount of time that a trip takes is dependent on the time at which the trip is taken.

The subject matter described herein provides a way to present a user with information about how long a trip will take based on the time of day at which the trip is taken. Historical information is collected about how long it takes to travel between various points at various times of day. For example, with regard to car travel, a sensor could detect the speed of traffic at a particular point on a road, and could provide data concerning the speed detected and the day and time at which the speed was detected. In such an example, the data collected indicates how long it takes to travel past the location of the sensor. This data then may be collected in bins, representing different times of days, or possibly different days. For example, a bin might represent the 1 a.m. to 2 a.m. time slot, or might represent the 1 a.m. to 2 a.m. Monday time slot (with there being different 1-2 a.m. slots for different days of the week), or might represent the 1 a.m. to 2 a.m. weekday time slot (with there being a different 1-2 a.m. slot for the weekend). When sufficient data has been collected, an average for each bin can be created. In this example, the average would indicate the typical speed for the observed point of the road within a given time interval. A similar set of bins could be created for each observable point of road, and averages can be calculated for each bin. Therefore, it is possible to know how fast a road typically moves at a particular time of day.

Using the information about how fast traffic moves at a particular time of day, it is possible to calculate how long it will take to travel a route at different times of day. For example, a route might take fourteen minutes to travel in the middle of the night when there is no traffic, but might take over an hour to travel during rush hour. Therefore, an application can present, to a user, information that reflects how long it will take to travel a route at a given time of day. For example, the application could present a table that shows the different travel times at different hours of a day. Or, it could present a graph showing how the travel time changes throughout the day. Or, the application could ask the user at what time of day he or she wishes to travel, and could plan a route that is likely to minimize the travel time at that time of day.

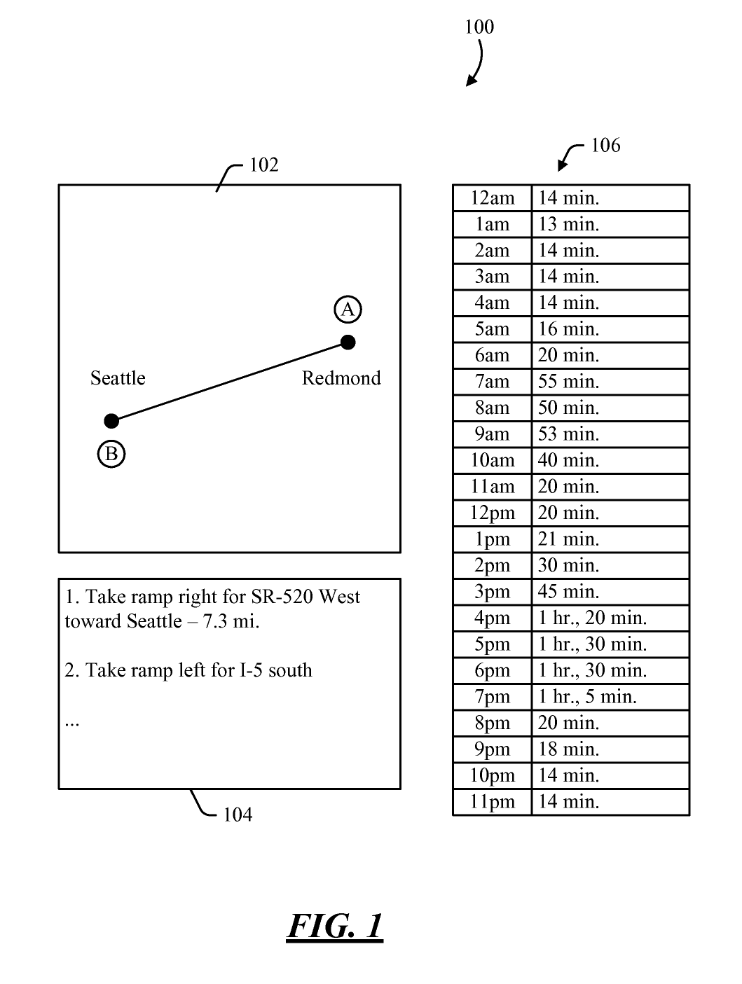

Turning now to the drawings, FIG. 1 shows an example of information 100 that an application could present to a user concerning a route between two points, and the amount of time that it will take to traverse the route. Information 100 may, for example, be displayed by an on-line map application that has been asked to provide directions. In this example, a user has asked the map application for directions from Redmond, Wash. (point A) to Seattle, Wash. (point B). The application provides a map 102 of the route. (In the example of FIG. 1, the route is shown in abstract form as a line; it will be understood that a map application would typically show the route on a street map having some level of detail.) In addition to showing the route on map 102, the application may also provide, in the form of text, directions 104 on how to follow the route. In this example, directions 102 begin with the instruction “Take ramp right for SR-520 West toward Seattle—7.3 mi.,” followed by “Take ramp left for I-5 south.”

The application may also provide information about how long it will take a driver to travel the route. This information could be presented in various forms. In the example shown in FIG. 1, the information is presented in the form of table 106, which specifies how long it is estimated to drive the route during specific hours. For example, at the hour that begins at 12 a.m. (i.e., 12:00 a.m. to 1:00 a.m.), it is estimated to take 14 minutes to drive the route. At the hour that begins at 1:00 a.m., it is estimated to take 13 minutes to drive the route. In general, table 106 reflects that the route is clear in the middle of the night, and there might be no appreciable difference between 12 a.m. and 1 a.m.—i.e., it is possible that the difference in travel time between those two hours (14 minutes versus 13 minutes) may simply be measurement error. However, the application in this example has access to time-dependent traffic information for each hour, and therefore it can calculate a different time for each hour if any such difference is reflected in the underlying data.

Table 106 is merely one way to show the user how travel time varies throughout the day. In general, once an application has information about how travel time varies throughout the day, it can use that information in various ways to provide the user with an indication of how long it will take to traverse the route at various times of day. Some other ways of using and/or presenting this information are described below.

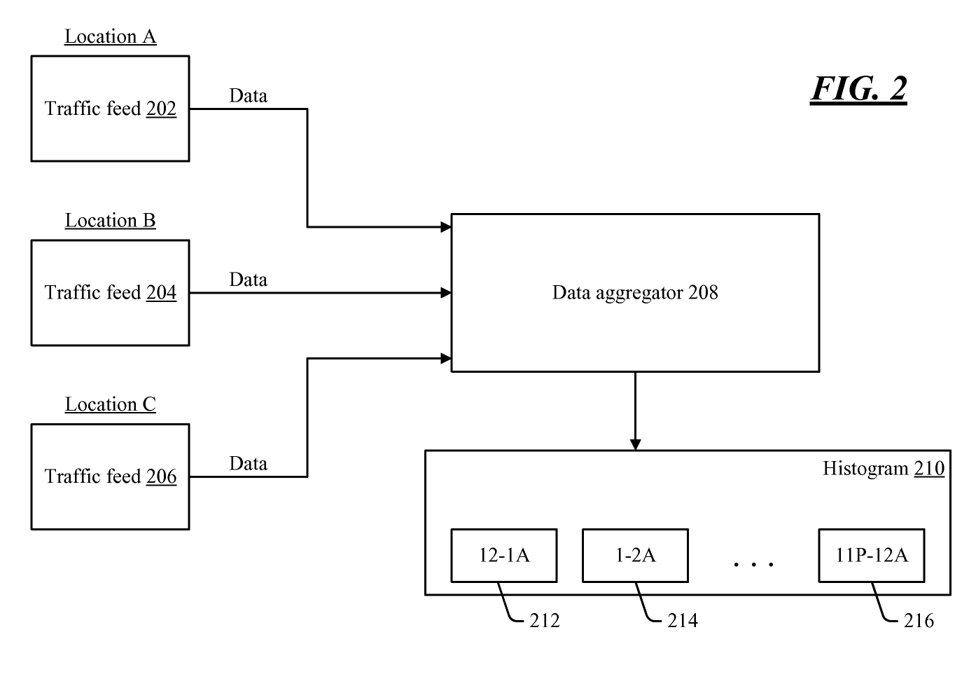

FIG. 2 shows an example system that may collect data about traffic conditions. In the example of FIG. 2, data is collected in the form of traffic feeds (e.g., Really Simple Syndication, or “RSS” feeds), that come from various locations. Each location may, for example, have a speed detector placed at some point along a road, which detects the speed of traffic at that point. Thus, traffic feed 202 reports on the speed of traffic at location A, traffic feed 204 reports on the speed of traffic at location B, and traffic feed 206 reports on the speed of traffic at location C. Each traffic feed sends data to data aggregator 208, which collects the traffic data. The data communicated through traffic feeds 202-206 may comprise, for example, a detected speed of traffic along with the day and time at which the detection was made. For example, a particular item of data in traffic feed 202 might say, “19 m.p.h. Tuesday, 2:36 p.m.”. This data would indicate that, at location A, traffic was found to be moving at 19 miles per hour on a Tuesday at 2:36. This type of data is collected by data aggregator 208.

For each location on which data is reported, data aggregator 208 may create a histogram 210, which groups data based on the time to which the data relates. For example, histogram 210 has bins for each hour of a day—e.g., bin 212 is for the 12 a.m. to 1 a.m. hour, bin 214 is for the 1 a.m. to 2 a.m. hour, and bin 216 is for the 11 p.m. to 12 a.m. hour. Providing a bin for each hour of the day is merely one example of how the bins could be arranged. For example, there could be a bin for each two-hour interval, or for each half-hour interval, or for any other interval. Moreover, there could be bins for different hours of different days. For example, as noted above, there might be seven different 1 a.m. to 2 a.m. bins, one for each day of the week, or there might be two different 1 a.m. to 2 a.m. bins, one for weekdays and one for weekends. In general, a bin could be created for any type of time interval.

Histogram 210 collects data received from traffic feeds 202-206 on a continuing basis. When histogram 210 has sufficient data to create meaningful averages, the data in each bin is averaged in order to determine the typical state of traffic in the time interval represented by each of the bins. As noted above, each location for which traffic data is collected may have its own histogram. Therefore, if histogram 210 is the histogram for traffic feed 202 (corresponding to location A), then the average of data points in bin 212 may represent the state of traffic (e.g., the average traffic speed) at location A from 12 a.m. to 1 a.m., and the average of data points in bin 214 may represent the state of traffic at location A from 1 a.m. to 2 a.m., and so on.

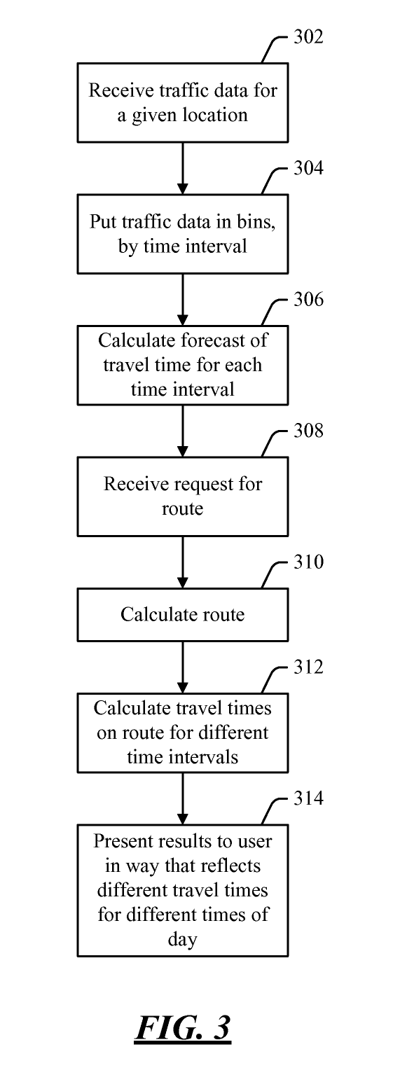

FIG. 3 shows, in the form of a flow chart, an example process in which data may be collected about traffic patterns at different times, and in which such data may be used to provide information about how long it will take to travel a route. Before turning to a description of FIG. 3, it is noted that the flow diagram contained in that figure is described, by way of example, with reference to components shown in FIGS. 1 and 2, although this process may be carried out in any system and is not limited to the scenario shown in FIGS. 1 and 2. Additionally, the flow diagram in FIG. 3 shows an example in which stages of a process are carried out in a particular order, as indicated by the lines connecting the blocks, but the various stages shown in these diagrams can be performed in any order, or in any combination or sub-combination.

At 302, traffic data for a given location is received. The data may be received in any form. For example, as shown in FIG. 2 and discussed above, there may be various sensors that gather information about the speed of traffic that passes a particular point, and data from each of the sensors may be received in the form of a feed. However, receiving sensor data in the form of feeds is merely an example, and the data could be received and/or provided in any form.

At 304, the received traffic data is put in bins, based on the time interval to which it relates. As described above, for each location about which data is collected, a histogram containing several bins could be created, and, within a histogram, there could be a bin for each hour of the day. As data for a particular location is received, the data could be put into a particular bin based on the time of day into which the data falls.

At 306, a forecast is calculated for a particular time interval. For example, there may be several data points collected in the 4 p.m. to 5 p.m. interval. Each data point might indicate a speed of traffic that was observed at some point during that time interval. The different data points could be averaged to determine the average speed at which traffic moves at a given location between the hours of 4 p.m. and 5 p.m.

At some point in time, an application receives a request to provide a route (at 308). For example, an on-line mapping application (e.g., Bing Maps) might receive a request to provide directions from one place to another (e.g., from Redmond to Seattle, as in the example of FIG. 1). The application then calculates a route (at 310), and calculates the various travel times for the route at different time intervals (at 312). It is noted that the route that is calculated may be dependent on data concerning how long it would take to travel different routes at different times of day. For example, the application might allow a user to indicate when he will travel the requested route. If the user says that he will travel at 2:00 in the afternoon, then the application might route him on a fast expressway. On the other hand, if the user says that he will travel at 5:00 in the afternoon, then data might indicate that the expressway slows significantly, so the application might route the user on slower, but less crowded, back roads.

At 314, the route and the travel-time calculations are presented to the user. These results may be presented in various ways. For example, FIG. 1, as discussed above, shows a case where the application provides a map and driving directions to the user, and also provides a table showing how long it will take to travel the suggested route at all of the different one-hour intervals throughout a day. For example, in table 106 of FIG. 1, the line marked “12 am” indicates how the predicted travel time for a trip occurring between 12 a.m. and 1 a.m. However, FIG. 1 shows merely one example of how to present information to a user.

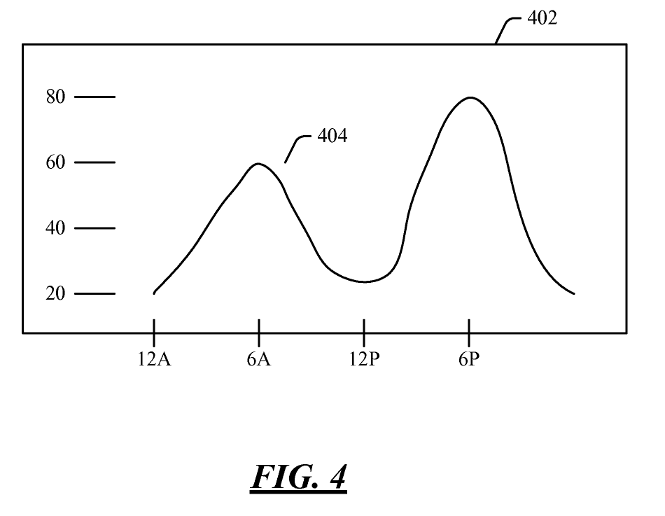

FIG. 4 shows another example of how to present information to a user about the travel times for different routes. In FIG. 4, the amount of time it takes to travel a route at various different times of day is shown in the form of graph 402. Graph 402 contains a horizontal axis showing the various times of day (e.g., 12 a.m., 6 a.m., 12 p.m., and 6 p.m.), and a vertical axis showing the number of minutes It takes to travel a route (from zero to eighty minutes are shown). Graph 402 also contains curve 404, which moves upward or downward through time, thereby showing how the number of minutes it takes to travel a route changes based on the time that the route is traveled.

However, in addition to the examples of FIGS. 1 and 4, there are several other ways that information about traffic patterns can be shown to a user and/or used to calculate a route.

In one example, the user interface that shows the route could be made interactive. Thus, the interface could provide a control (e.g., a slider) that allows the users to move through different times of day. As the user moves, portions of the route shown on a map could change colors—e.g., red for heavy traffic, yellow for moderate traffic, and green for light traffic. As a variation on this idea, moving the slider could alter the route. For example, the application that provides the route might choose to provide a route that takes the shortest time to travel. As the user moves the slider to different times of day, the route that takes the shortest time to travel could change, and therefore the route shown to the user could change based on what time of day the user is indicating with the slider. As a further variation on this theme, the user might specify that he wants to travel at whatever time of day would take the least amount of time to travel. Thus, the application could pick the combination of a route and a time that would take the least time to travel.

Additionally, the time at which the user will travel could be mined from the user's calendar (assuming, of course, that appropriate permission to use the calendar was obtained from the user, in order to respect the privacy of the user's calendar). Thus, if the user has a meeting on his calendar at a specific location, directions could be calculated from the user's office to the meeting location, and the travel time for the directions could be chosen based on the time that the meeting is to take place. For example, if the user has a meeting at 2:00 p.m., the user could be given directions to the meeting, along with an estimate of how long it will take to traverse the route specified in the directions during the 1-2 p.m. hour.

Moreover, the amount of time that it takes to traverse a route could take into account how traffic patterns will change during the time that the route is being traveled. For very short routes (e.g., a few miles), it may be reasonable to assume that the entire route will be traversed within a specific hour. However, for longer routes (e.g., Seattle to Portland), the traffic patterns may change while the route is being traversed. For example, if the user leaves Seattle at noon heading toward Portland, traffic may be clear in Seattle at noon, but by the time the user arrives in Portland a few hours later, the user may be driving through heavy rush hour traffic. Thus, different time intervals may be used to estimate the time to traverse different portions of the route. For example, the 12-1 p.m. interval may be used to estimate traffic patterns at the beginning of the route in Seattle, but the 4-5 p.m. interval may be used to estimate traffic near the end of the route in Portland, since it is likely to be around four o'clock when the user arrives in Portland.

Additionally, it is noted that driving is merely one mode of transportation for which travel time can be estimated. In other examples, travel time for walking, trains, busses, planes, etc., can be estimated. In the case of public transportation vehicles that leave at specific times, the schedule of the public transportation vehicles can be considered in determining the travel time. For example, if a bus leaves at :00, and :30 after each hour, then the amount of travel time may include, say, 29 minutes of wait time if the user begins his journey at 1:01 in the afternoon, since the next train will not leave for another 29 minutes. The user could provide an indication of what mode of travel the user intends to use, and directions and travel times could be provided that are appropriate to the user's intended mode of travel.

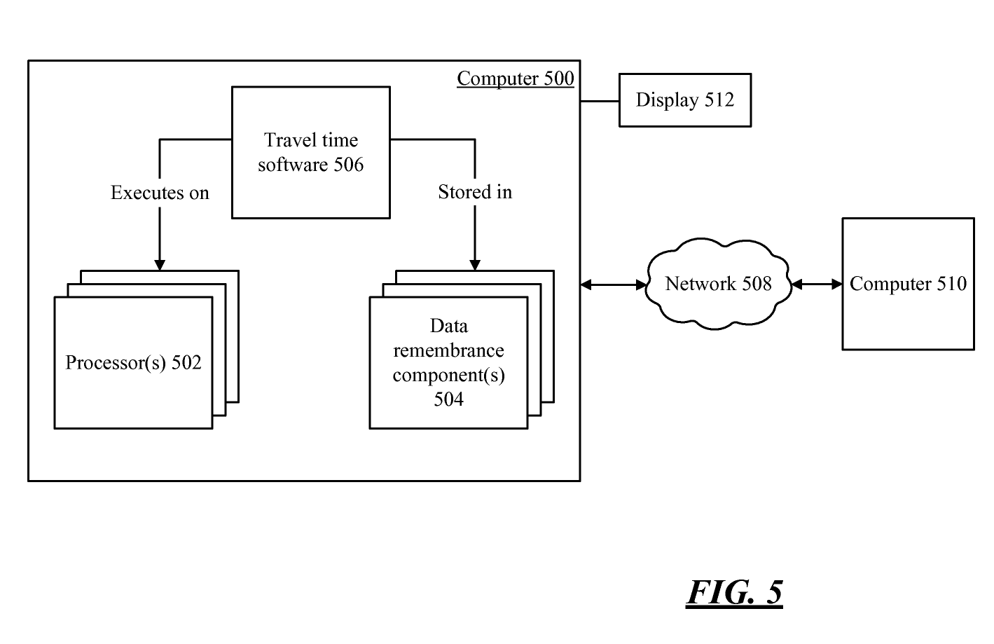

FIG. 5 shows an example environment in which aspects of the subject matter described herein may be deployed.

Computer 500 includes one or more processors 502 and one or more data remembrance components 504. Processor(s) 502 are typically microprocessors, such as those found in a personal desktop or laptop computer, a server, a handheld computer, or another kind of computing device. Data remembrance component(s) 504 are components that are capable of storing data for either the short or long term. Examples of data remembrance component(s) 504 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 500 may comprise, or be associated with, display 512, which may be a cathode ray tube (CRT) monitor, a liquid crystal display (LCD) monitor, or any other type of monitor.

Software may be stored in the data remembrance component(s) 504, and may execute on the one or more processor(s) 502. An example of such software is travel time estimation software 506, which may implement some or all of the functionality described above in connection with FIGS. 1-4, although any type of software could be used. Software 506 may be implemented, for example, through one or more components, which may be components in a distributed system, separate files, separate functions, separate objects, separate lines of code, etc. A personal computer in which a program is stored on hard disk, loaded into RAM, and executed on the computer's processor(s) typifies the scenario depicted in FIG. 5, although the subject matter described herein is not limited to this example.

The subject matter described herein can be implemented as software that is stored in one or more of the data remembrance component(s) 504 and that executes on one or more of the processor(s) 502. As another example, the subject matter can be implemented as instructions that are stored on one or more computer-readable storage media. (Tangible media, such as an optical disks or magnetic disks, are examples of storage media.) Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium.

Additionally, any acts described herein (whether or not shown in a diagram) may be performed by a processor (e.g., one or more of processors 502) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 500 may be communicatively connected to one or more other devices through network 508. Computer 510, which may be similar in structure to computer 500, is an example of a device that can be connected to computer 500, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage media that store executable instructions to provide travel directions, wherein the executable instructions, when executed by a computer, cause the computer to perform acts comprising:
receiving, from a user, a request to provide a directions from a first location to a second location;
calculating a route from said first location to said second location;
calculating a travel time that to traverse said route, said travel time being based on said travel occurring during a particular time interval, and also being based on historical traffic data collected for said particular time interval; and
communicating, to said user, said route and said travel time.

2. The one or more computer-readable storage media of claim 1, wherein said acts further comprise:
calculating a plurality of travel times to traverse said route during a plurality of time intervals, said travel time being one of said plurality of travel times, said particular time interval being one of said plurality of time intervals.

3. The one or more computer-readable storage media of claim 2, further comprising:
presenting, to said user, an indication of how long it will take to traverse said route during each of said plurality of time intervals.

4. The one or more computer-readable storage media of claim 3, wherein said indication comprises a table of travel times for each of said plurality of time intervals.

5. The one or more computer-readable storage media of claim 3, wherein said indication comprises a graph showing how an amount of time that it takes to traverse said route varies over time.

6. The one or more computer-readable storage media of claim 2, further comprising:
receiving, from said user, an indication of a time at which said user wants to travel from said first location to said second location; and
choosing said route from said first location to said second location that minimizes an amount of time to travel from said first location to said second location at said time.

7. The one or more computer-readable storage media of claim 2, further comprising:
receiving, from said user, an indication that said user wants to travel at a time that minimizes an amount of time that it takes to travel from said first location to said second location; and
choosing said route and said time interval based on said route and said time interval being a combination that minimizes how long it takes to travel from said first location to said second location.

8. The one or more computer-readable storage media of claim 1, further comprising:
receiving a plurality of traffic data for a plurality of times;
putting each item of traffic data in a bin based on a time interval into which each item of traffic data falls;
calculating a speed of traffic for each time interval represented by each bin; and
using each speed of traffic to determine how long it will take to travel said route at different times of day.

9. A method of providing travel directions, the method comprising:
using a processor to perform acts comprising:
receiving a plurality of traffic data for a first location, each of the traffic data being collected at a time;
putting said traffic data into bins based on a time at which said traffic data was collected, each of the bins representing a time interval;
calculating a speed of traffic at each time interval based on data in the bins associated with each time interval;
receiving a request to provide directions from a second location to a third location, said first location being between said second location and said third location;
calculating a route from said second location to said third location;
using calculated speeds of traffic at each time interval to determine how long it will take to traverse said route during different time intervals; and
communicating, to a user, said route and an indication of how long it will take to traverse said route at each time interval.

10. The method of claim 9, wherein said communicating comprises:
presenting a table of time intervals and an amount of time that it will take to traverse each route at each of said time intervals.

11. The method of claim 9, wherein said communicating comprises:
presenting a graph showing how an amount of time that it takes to traverse said route changes over time.

12. The method of claim 9, wherein said acts further comprise:
receiving, from said user, a list of intermediate points to which said user wants to travel as said user travels between said second location and said third location;
wherein said route is calculated to pass through said intermediate points.

13. The method of claim 9, wherein said acts further comprise:
receiving, from a calendar of said user, an indication of a place to which said user will travel and a particular time at which said user is to travel to said place, said place being said third location;
and wherein said communicating comprises:
communicating, to said user, an indication of how long it will take to travel to said place at said particular time.

14. A system for presenting directions and travel time, the system comprising:
a processor;
a memory;
a component that is stored in said memory and that executes on said processor, said component receiving data concerning travel speed at a first location, said data indicating a time at which said data was collected, said component receiving, from a user, a request to provide directions from a second location to a third location, said component calculating a route between said second location and said third location that includes said first location, said component using said data to calculate travel times, at a plurality of time intervals, between said second location and said third location, said component presenting, to said user, said route and an indication of a time it takes to traverse said route at each of the time intervals.

15. The system of claim 14, wherein said component receives an indication of a mode of travel that said user intends to use on said route, said mode of travel being either driving, walking, or public transportation.

16. The system of claim 14, wherein said component receives an indication that said user intends to travel said route using public transportation that departs at discrete times, and wherein said indication of travel times includes waiting time.

17. The system of claim 14, wherein said component puts said data in bins based on a time at which each item of said data is collected, each of said bins representing a particular time interval, and wherein said component uses data in each of said bins to calculate an amount of time that it takes to travel past said first location at each of the time intervals.

18. The system of claim 14, wherein said component determines at which time interval said route can be traversed in a shortest amount of time, and wherein said component indicates to said user which time of day allows said route to be traversed in a shortest amount of time.

19. The system of claim 14, wherein said component, in calculating an amount of time that it takes to travel said route at each of said time intervals, takes into account where said user will be after starting said route during each of the time intervals.

20. The system of claim 14, wherein said indication of a time it takes to traverse said route at each of the time intervals comprises a graph showing how an amount of time it takes to traverse said route changes through time.
